(19) United States
(12) Patent Application Publication
(10) Pub. No.: US 2011/0010036 A1
(43) Pub. Date: Jan. 13, 2011

(54) VELOCITY MONITOR

(76) Inventors: Richard D. Ridenour, II, Glendale, AZ (US); Jeffrey A. Weeldreyer, Phoenix, AZ (US)

Correspondence Address: Squire, Sanders & Dempsey L.L.P.;Two Renaissance Square, Suite 2700, 40 North Central Avenue, Phoenix, AZ, 85004-4498, US

(21) Appl. No.: 12/756,125

(22) Filed: Apr. 7, 2010

Related U.S. Application Data
(60) Provisional application No. 61/167,786, filed on Apr. 8, 2009.

(51) Int. Cl. G06F 7/00

(52) U.S. Cl. 701/29

(57) ABSTRACT

In one exemplary embodiment of the present invention, a medium stores instructions that, when executed by a provided processor, cause the processor to perform a method. The method includes: (a) receiving a reported position for an aircraft; (b) determining, based on the reported position for the aircraft, a minimum position and a maximum position for the aircraft along a first axis; (c) determining, based on the reported position for the aircraft, a minimum position and a maximum position for the aircraft along a second axis, the second axis perpendicular to the first axis; (d) receiving reported speed information for the aircraft; (e) determining a minimum possible speed and a maximum possible speed for the aircraft along the first axis; (f) determining a minimum possible speed and a maximum possible speed for the aircraft along the second axis; and (g) providing an alert if the reported speed information exceeds the minimum or maximum speeds along either the first axis or the second axis.

### CROSS-REFERENCE TO RELATED APPLICATION

This application claims priority to U.S. Provisional Patent Application Ser. No. 61/167,786, filed Apr. 8, 2009, the disclosure of which is incorporated by reference in its entirety.

### DESCRIPTION OF THE INVENTION

1. Field of the Invention

The present invention relates to systems and methods for monitoring velocity.

2. Background of the Invention

ADS-B Out equipped aircraft transmit a Navigation Accuracy Category for Velocity (NACv) to indicate the accuracy of their reported velocity. However, there is no guarantee that the NACv received from an aircraft is valid. As a result, little confidence can be given to the reported velocity. As a result, it is desirable for the ADS-B In equipped aircraft to validate the reported velocity received from the ADS-B Out traffic.

The Requirements Focus Group (RFG) and EUROCAE Working Group 51 have identified a need for a velocity check to support In Trail Procedures (ITP) as discussed in the EUROCAE document “SAFETY, PERFORMANCE AND INTEROPERABILITY REQUIREMENTS DOCUMENTS FOR ATSA-ITP APPLICATION,” which is incorporated by reference herein in its entirety. Current methods for solving this problem are often complicated and can result in false rejection of velocity reports. Systems and methods of the present invention are simple to implement and can run for arbitrarily long times and continue to give accurate results.

### SUMMARY OF THE INVENTION

The invention provides for a calculation of a minimum and maximum plausible speed for a moving object (e.g. ownship, a target aircraft, a UAV, a car, etc.) based on a plurality of position reports, each position report having an associated indication of the accuracy of the position. A tolerance, if appropriate, is added to the maximum plausible speed and subtracted from the minimum plausible speed. The resulting values become the maximum and minimum limits, respectively, for an acceptable velocity.

In one exemplary embodiment of the present invention, a medium stores instructions that, when executed by a provided processor, cause the processor to perform a method. The method includes: (a) receiving a reported position for an aircraft; (b) determining, based on the reported position for the aircraft, a minimum position and a maximum position for the aircraft along a first axis; (c) determining, based on the reported position for the aircraft, a minimum position and a maximum position for the aircraft along a second axis, the second axis perpendicular to the first axis; (d) receiving reported speed information for the aircraft;(e) determining a minimum possible speed and a maximum possible speed for the aircraft along the first axis; (f) determining a minimum possible speed and a maximum possible speed for the aircraft along the second axis; and (g) providing an alert if the reported speed information exceeds the minimum or maximum speeds along either the first axis or the second axis.

Both the foregoing summary and the following detailed description are exemplary and explanatory only and are not restrictive of the invention.

### BRIEF DESCRIPTION OF THE DRAWINGS

A more complete understanding of the present invention may be derived by referring to the detailed description and claims when considered in connection with the following illustrative figures.

FIG. 1 illustrates possible paths of an aircraft between tᵢ, and t_{f}.

FIG. 2 illustrates four examples of the number of time periods required based on different levels of Navigation Accuracy Category for Position (NACₚ) and the speed of an aircraft.

FIG. 3 illustrates various calculations that can be performed in accordance with aspects of the present invention.

FIG. 4 illustrates graphs depicting calculated velocity errors and calculated velocity errors as a percentage of reported velocity.

FIG. 5 illustrates additional aspects of velocity confirmation according to the present invention.

FIG. 6 illustrates an exemplary algorithm for velocity confirmation according to various aspects of the present invention.

FIG. 7 illustrates some advantages of the present invention over conventional systems.

### DESCRIPTION OF THE EMBODIMENTS

Reference will now be made in detail to the present exemplary embodiments of the invention, examples of which are illustrated in the accompanying drawings.

Sampling a value over a time interval to determine the time rate of change of the value is subject to various measurement inaccuracies. For instance, if the time interval is too small, the measurement errors of xi, xf, ti, and tf can cause large inaccuracies in the calculated rate: (x_{f}−xᵢ)/(t_{f}−tᵢ), where xᵢ, is the initial position, x_{f} is the final position, tᵢ, is the initial time, and t_{f} is the final time.

If the time interval is too large, the actual rate may be changing over the interval, such that the value suggested by (x_{f}−xᵢ)/(t_{f}−tᵢ) corresponds neither to the actual speed or velocity at time tᵢ, or time t_{f}. In addition, a large time interval induces lag in detecting a problem.

The present invention addresses these issues by having a variable time interval that is judiciously set based on the measurement errors an the required accuracy of the calculated rate.

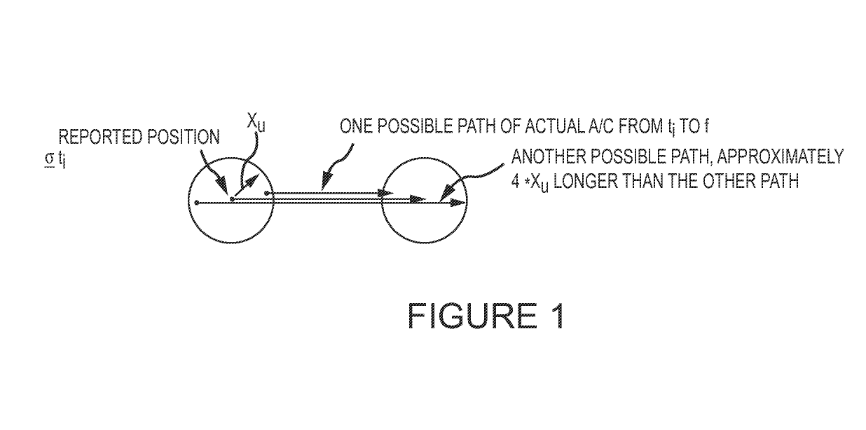

FIG. 1 illustrates possible paths of an aircraft between tᵢ, and t_{f}. For an xf of 0.3 nm (556 m), it would take approximately 55 seconds of interval to have a resulting error on the order of 10 m/s (556 m/55 sec≈10 m/s). Since there can be position error associated with both xi and xf, longer time intervals may be required.

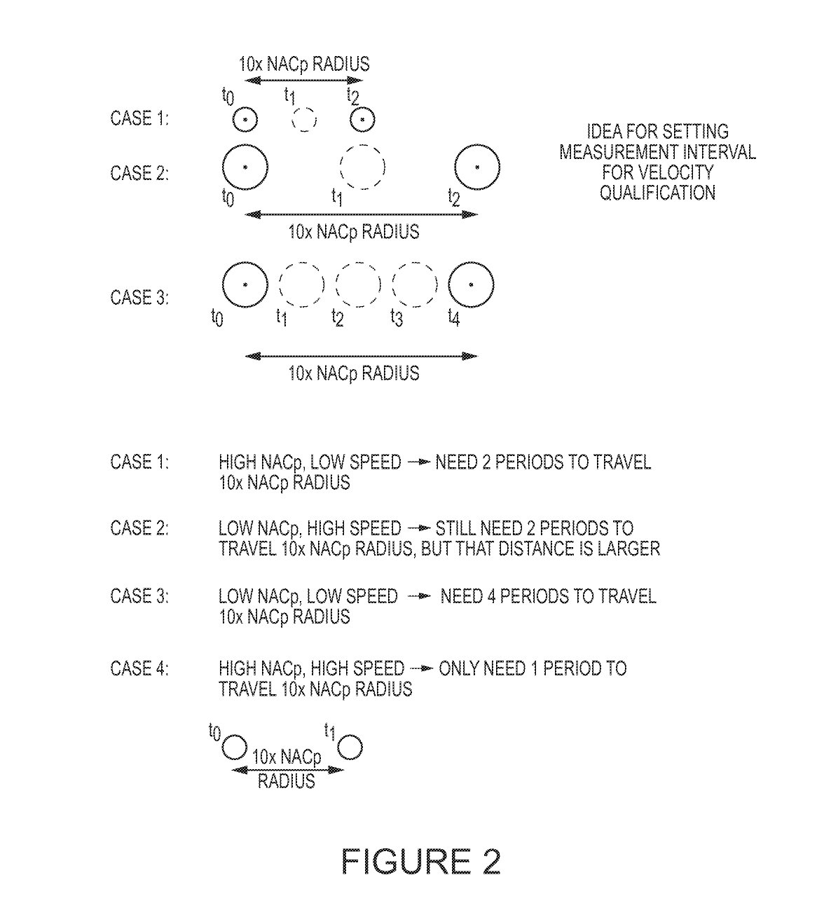

FIG. 2 illustrates four examples of the number of time periods required based on different levels of Navigation Accuracy Category for Position (NACₚ) and the speed of an aircraft.

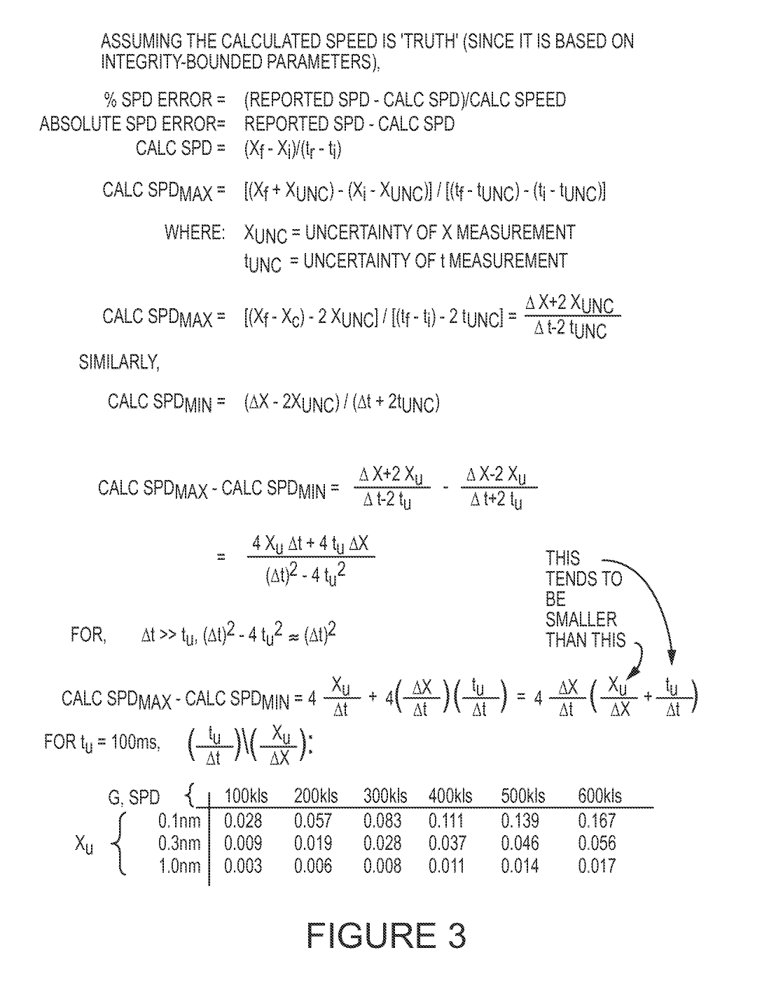

FIG. 3 illustrates various calculations that can be performed in accordance with aspects of the present invention. The table at the bottom of FIG. 3 illustrates that for typical aircraft speeds, typical position uncertainties and a time uncertainty of +/−100 ms, the relative time uncertainty is much smaller than the relative position uncertainty, and therefore the difference between the maximum and minimum possible speeds for a given time measurement interval can be approximated as:

CalcSPDₘₐₓ−CalcSPDₘᵢₙ≈4Xᵤ/(t_{f}−tᵢ).

It is noted that the speed range is: (1) independent of actual speed; (2) inversely proportional to (t_{f}−tᵢ); and (3) directly proportional to Xᵤ.

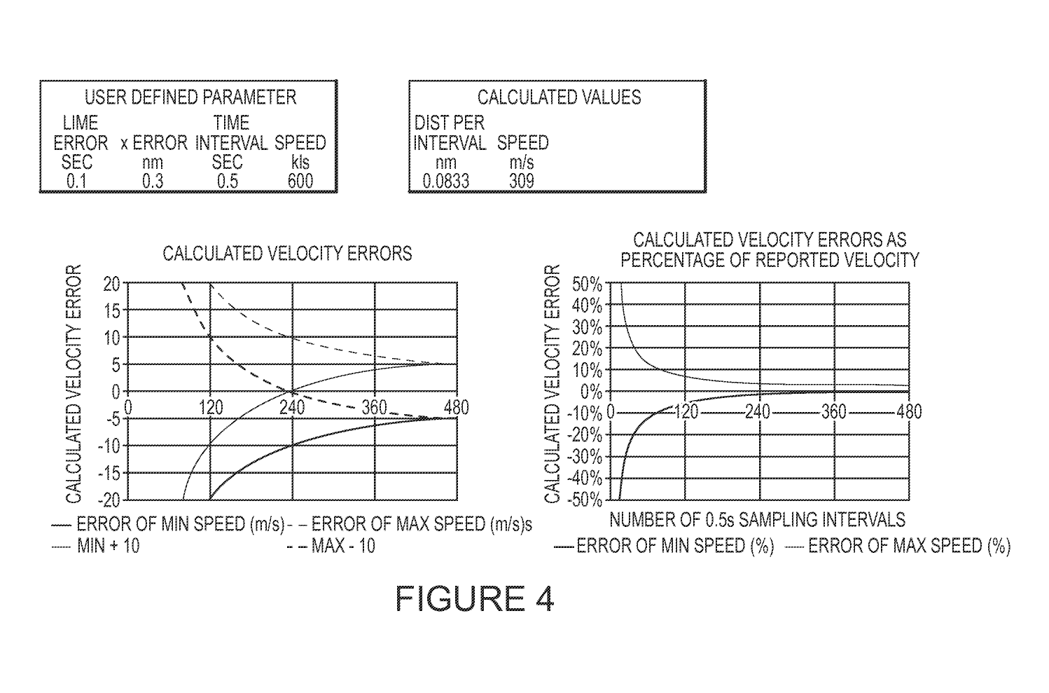

FIG. 4 illustrates graphs depicting calculated velocity errors and calculated velocity errors as a percentage of reported velocity.

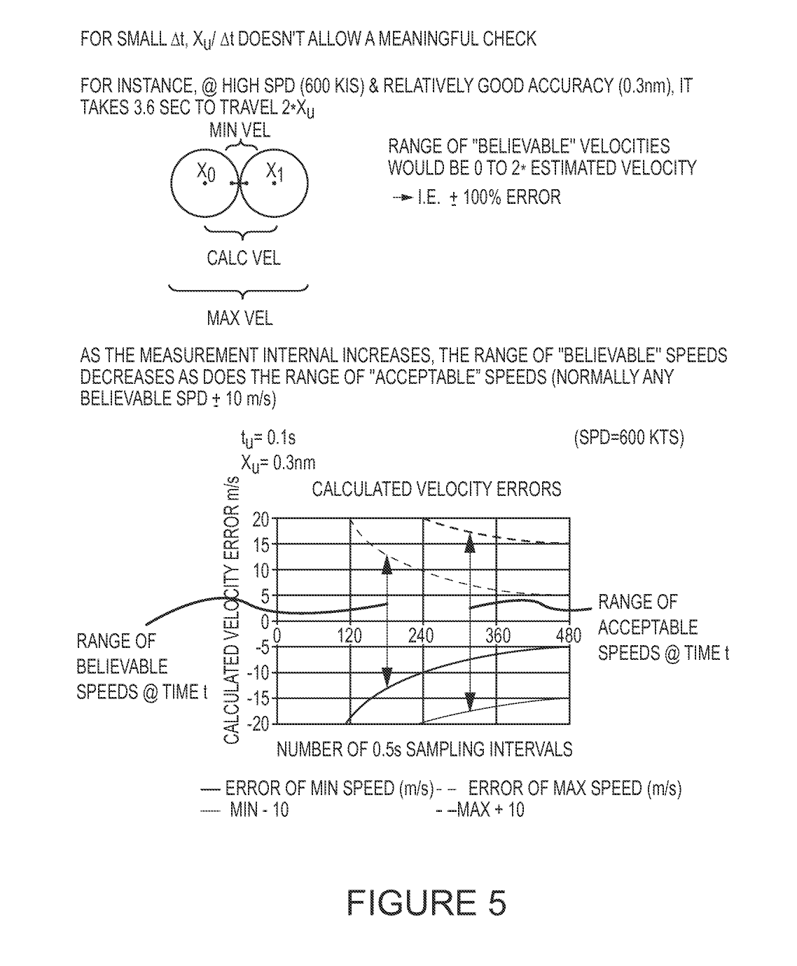

FIG. 5 illustrates additional aspects of velocity confirmation according to the present invention.

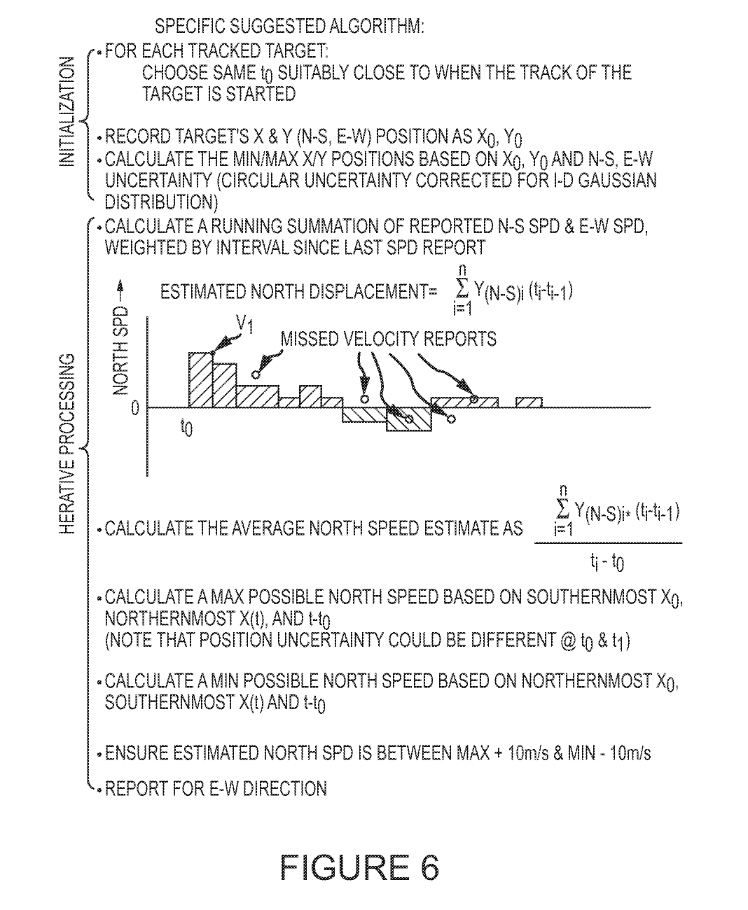

FIG. 6 illustrates an exemplary algorithm for velocity confirmation according to various aspects of the present invention.

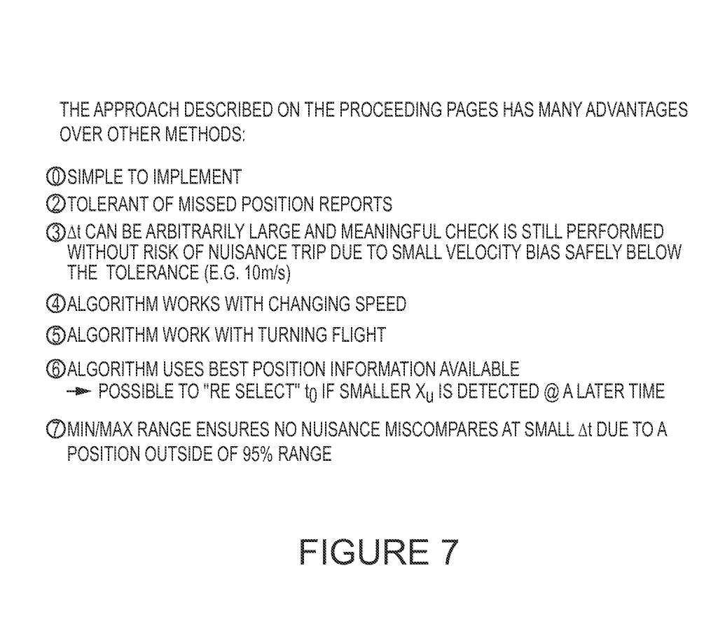

FIG. 7 illustrates some advantages of the present invention over conventional systems.

The functionality of the present invention can be implemented in any suitable manner, such as through a processor executing software instructions stored in a memory. Functionality may also be implemented through various hardware components storing machine-readable instructions, such as application-specific integrated circuits (ASICs), field-programmable gate arrays (FPGAs) and/or complex programmable logic devices (CPLDs). Systems of the present invention may operate in conjunction with any desired combination of software and/or hardware components.

Any number and type of processor(s) such as an integrated circuit microprocessor, microcontroller, and/or digital signal processor (DSP), can be used in conjunction with the present invention. Likewise, a memory operating in conjunction with the present invention may include any combination of different memory storage devices, such as hard drives, random access memory (RAM), read only memory (ROM), FLASH memory, or any other type of volatile and/or nonvolatile memory.

The particular implementations shown and described above are illustrative of the invention and its best mode and are not intended to otherwise limit the scope of the present invention in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the invention. Furthermore, the connecting lines shown in the various figures are intended to represent exemplary functional relationships and/or physical couplings between the various elements. Many alternative or additional functional relationships or physical connections may be present in a practical system.

Changes and modifications may be made to the disclosed embodiments without departing from the scope of the present invention. These and other changes or modifications are intended to be included within the scope of the present invention, as expressed in the following claims.

What is claimed is:

1. A medium storing instructions that, when executed by a provided processor, cause the processor to perform a method comprising:
(a) receiving a reported position for an aircraft;
(b) determining, based on the reported position for the aircraft, a minimum position and a maximum position for the aircraft along a first axis;
(c) determining, based on the reported position for the aircraft, a minimum position and a maximum position for the aircraft along a second axis, the second axis perpendicular to the first axis;
(d) receiving reported speed information for the aircraft;
(e) determining a minimum possible speed and a maximum possible speed for the aircraft along the first axis;
(f) determining a minimum possible speed and a maximum possible speed for the aircraft along the second axis; and
(g) providing an alert if the reported speed information exceeds the minimum or maximum speeds along either the first axis or the second axis.
